(19) United States
(12) Patent Application Publication
(10) Pub. No.: US 2011/0271949 A1
(43) Pub. Date: Nov. 10, 2011

(54) CHARCOAL GRILL

(76) Inventors: Matthew Ortner, Greenwood, MS (US); Brent Bailey, Greenwood, MS (US)

(21) Appl. No.: 13/100,651

(22) Filed: May 4, 2011

Related U.S. Application Data
(60) Provisional application No. 61/332,076, filed on May 6, 2010.

(51) Int. Cl. A47J 37/07

(52) U.S. Cl. 126/25 R

(57) ABSTRACT

A charcoal grill assembly including a body housing a top or lid pivotally attached to a bottom portion. A charcoal grate is received within the bottom portion, with a cooking grate received over the charcoal grate. The cooking grate includes a hingedly attached portion that can be pivoted upwardly to provide access to the charcoal grate therebelow. An ash collection system is mounted below the bottom portion of the grill body for discharge and collection of ashes from the grill. The grill body further is mounted on a series of legs that support the grill.

### CROSS-REFERENCE TO RELATED APPLICATION

The present Patent Application is a formalization of previously filed, co-pending U.S. Provisional Patent Application Ser. No. 61/332,076, filed May 6, 2010 by the inventor named in the present Application. This Patent Application claims the benefit of the filing date of this cited Provisional Patent Application according to the statutes and rules governing provisional patent applications, particularly 35 U.S.C. §119(a)(i) and 37 C.F.R. §1.78(a)(4) and (a)(5). The specification and drawings of the Provisional Patent Application referenced above are specifically incorporated herein by reference as if set forth in their entirety.

### FIELD OF THE INVENTION

The present disclosure generally relates to an outdoor grill. More specifically, the present disclosure relates to an outdoor grill, such as a charcoal grill, with novel designs and features.

### BACKGROUND OF THE INVENTION

Grilling or cooking outdoors has become increasingly popular among consumers. While gas fired grills and electric grills have become more popular in recent years, many consumers still prefer the taste or flavoring of food cooked over charcoal flames. Also, gas and electric grills generally are significantly more expensive than charcoal grills. As a result, charcoal grills still remain a very popular alternative to gas grills, especially among consumers with limited outdoor space such as persons living in apartments or the like and/or consumers who do not wish to take on the significant expense of many gas or electric grills. However, while generally cheaper than most gas grills, consumers still desire the stability and many of the features found on gas grills, including a desire for easy clean up and use with a strong, durable construction, in a charcoal grill.

Accordingly, it can be seen that a need exists for a charcoal grill assembly that addresses the foregoing and other related and unrelated problems in the art.

### SUMMARY OF THE INVENTION

Briefly described, the present invention generally relates to a charcoal grill assembly having an enhanced construction to provide increased strength, durability, and ease of use for cooking and cleaning of the grill. The charcoal grill includes a body having a generally U-shaped or concave first or bottom portion that defines a cooking or grilling area; and a domed upper end or top that generally is hingedly connected to the bottom. A charcoal grate for supporting charcoal briquettes or the like generally will be mounted within a lower portion of the bottom, while a cooking grate will be mounted within the cooking area of the bottom portion, spaced above the charcoal grate. The cooking grate further generally will be hinged along an intermediate portion thereof so as to enable at least a portion of the cooking grate to be pivoted upwardly and away from the charcoal grate to enable easy access to the charcoal grate for addition of more charcoal briquettes and/or cleaning.

The top generally will be hingedly attached to the bottom portion of the grill body by a pair of hinges at peripheral side edges thereof. Each of the hinges can include a cast hinge base formed with the bottom portion of the grill body, and a top hinge portion that can be cast with or otherwise fixedly attached to the top of the grill body, with the top portion of each of the hinges having a lower section or tongue that will seat within and connect to the base portions by hinge pins to provide a stable, secure pivotal attachment of the top to the bottom of the grill body. This enables the top to be pivoted upwardly and away from the cooking or grilling area so as to enable substantially complete access to the cooking grate, while maintaining the top in a connected arrangement with the bottom of the grill.

Additionally, the grill body can be supported on a series of legs, with at least two of the legs further mounted to wheels or rollers to enable the grill to be rolled or moved to a desired location. A shelf also can be provided at the bottom of the grill for additional storage and to provide further stability to the bottom ends of the legs. Still further, the grill will be provided with an ash collection system mounted to the bottom or base of the grill body. The ash collection system generally will include an upper ash collector on the underside of the bottom or base of the grill body. A vent generally will be provided at the lower end of the bottom of the grill body, opening into the upper ash collector, which vent further will include a lever or operation handle that extends outwardly from the upper ash collector to enable the user to open and close the vent as needed or desired for removal of ash from the grill body. An ash catch pan generally is slidably received along a lower portion of the upper ash collector for collection of the ash being discarded or discharged from the grill body, which ash catch pan can be easily removed from the ash collector for discarding the collected ash.

Those skilled in the art will appreciate the above-stated advantages and other advantages and benefits of various additional embodiments upon reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 shows a front perspective view of one embodiment of a grill according to the principles of the present invention.

FIG. 2 shows a perspective view of the interior of the grill of FIG. 1 with the lid open.

FIGS. 3A-3C show one embodiment of the grate system of the grill of FIG. 1.

FIGS. 4A-4B show exploded views of one embodiment of a handle assembly for the grill of FIG. 1.

FIG. 5 shows an exploded rear view of the grill of FIG. 1 illustrating the hinge for connecting the lid and bottom portion of the grill.

FIGS. 6A-6D show the ash collecting system, including the ash catch pan thereof, of the grill of FIG. 1.

Corresponding parts are designated by corresponding reference numbers throughout the drawings.

### DETAILED DESCRIPTION

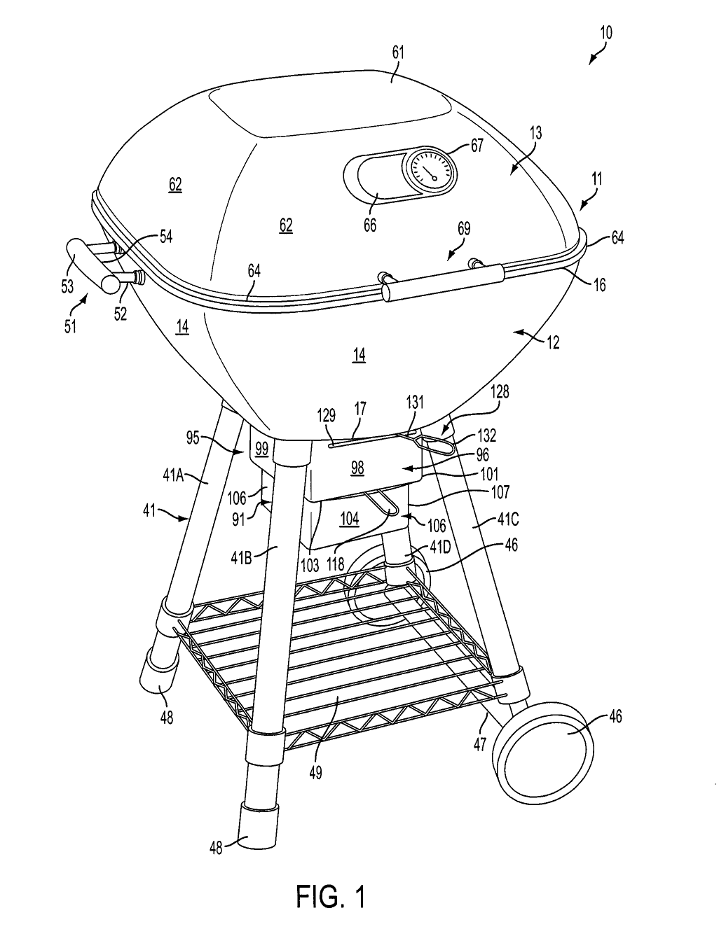

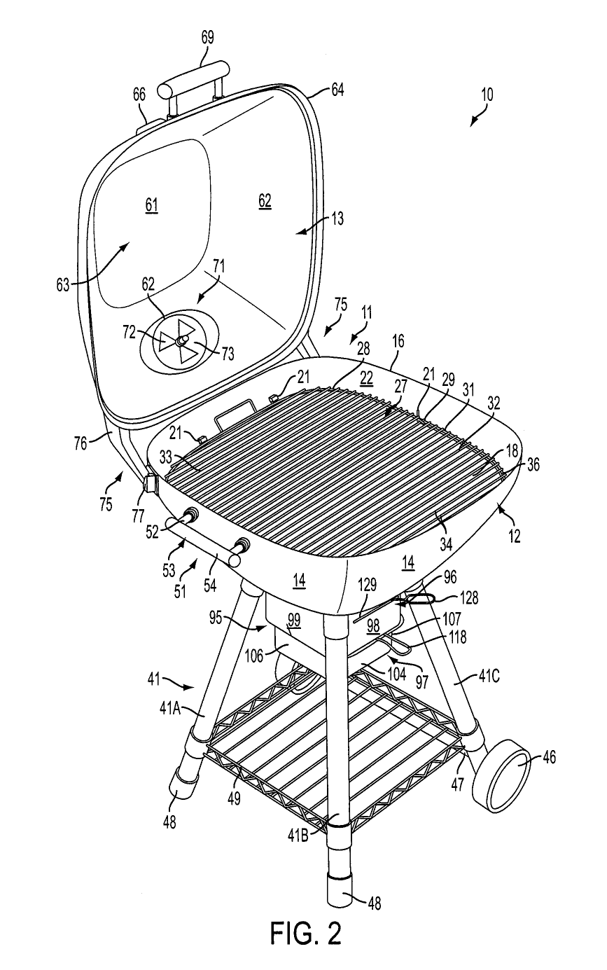

Referring now to the drawings, FIG. 1 shows a front perspective view of one embodiment of a charcoal grill 10 according to the principles of the present invention, while FIG. 2 shows a view of the interior of the grill 10 of FIG. 1 in an opened configuration. The grill 10 generally will include a body 11 having a bottom or lower portion 12 and a lid or top portion 13. The bottom and top portions of the grill body 11 generally will be formed from a high-strength metal material, such as steel or aluminum capable of withstanding the heat of burning charcoal coals during cooking, and typically will be painted or powder coated in a desired color and/or with a desired coating such as an enamel paint or powder coating to provide a desired decorative and weather-resistant finish. It also will be understood by those skilled in the art that the parts of the grill discussed below and illustrated in the drawings are shown and/or listed with exemplary features and/or materials. Such exemplary materials, features, colors, textures, shapes, configurations, sizes, and other features can, however, be varied without deviating from the spirit and scope of the present invention. For example, in lieu of “spot welding,” parts can be secured by other means such as pressure friction or fitting, releasable fasteners, snap connectors, slide connectors, etc. As a further example, the colors and/or textures of the various elements or parts of the present grill can be changed as needed or desired to provide different visual appearances and/or textures to the grill.

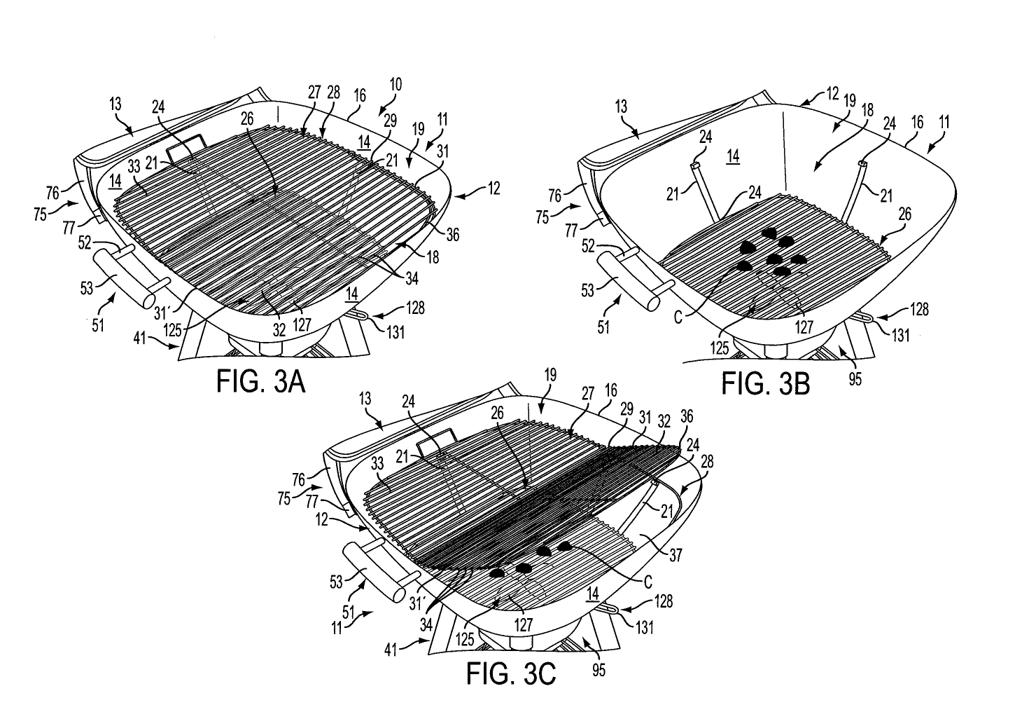

As generally illustrated in FIGS. 3A-3C, the bottom 12 of the grill body 11 generally is provided with a substantially concave shape or construction and typically includes a series of side walls 14 that slope downwardly from a first, proximal or upper end 16 to a second, lower or distal end 17. The side walls 14 thus define a firebox 18 with a cooking area or grilling area 19 adjacent the upper end thereof. It further will be understood by those skilled in the art that while the grill has been shown with a substantially square configuration, other configurations including substantially round or oval, rectangular, etc. also can be utilized. As shown in FIG. 3B, a series of grate supports 21 generally will be mounted to the interior surfaces 22 of the side walls 14 of the bottom portion 12. Each of the grate supports 21 generally will include an elongated body 23 with inwardly projecting ledges 24 adjacent the upper and lower ends thereof. The ledges 24 will generally support a lower or charcoal grate 26, which is received on the lower ledges as indicated in FIG. 3B, and a cooking grate 27 which is received and supported on the upper ledges of the grate supports as indicated in FIGS. 3A and 3C. Additionally, it will be understood that while the grate supports 21 are shown as including pairs of ledges, it is also possible to use individual grate supports having a single ledge for supporting the charcoal and cooking grates as needed; for example, additional supports for the cooking grate can be provided at additional spaced locations about the interior of the bottom portion of the grill body.

As indicated in FIGS. 2 and 3B-3C, the charcoal grate 26 generally will be received on the lower ledges of the grate supports, at a first elevation positioned below and spaced from the cooking grate 27, which will be placed and/or received at a second, higher elevation adjacent the upper end 16 of the bottom portion 12 of the grill body 11. The charcoal grate generally will receive charcoal briquettes or coals C as indicated in FIGS. 3B and 3C, with the coals generally being stacked thereon for providing a heating source for cooking food placed on the cooking grate 27, above the charcoal grate. Both the charcoal grate and the cooking grate further generally will be formed from a metal material, such as steel, aluminum, or from various ceramic materials, having a high resistance to heat, and further can be powder coated with a non-stick coating. As additionally indicated in FIG. 3C, the cooking grate 27 further generally will include an outer frame 28 to which the hinges 29 are attached along side edges 31/31′ thereof, and first and second grate sections 32 and 33.

As indicated in FIG. 3C, each grate section 32/33 generally will include a series of laterally extending cross pieces 34 with the cross pieces of the first grate section being attached to an arcuate support 36, the ends of which are attached to the hinges 29 so that the first grate section 32 can be pivoted upwardly and away from the frame 31 and away from the charcoal grate 26, thus defining an access opening 37 in the cooking grate. This access opening 37 enables the user to have access to the charcoal grate as needed for adding additional coals or for spreading the coals, etc. during cooking, without having to physically remove the cooking grate. Instead, the user can simply shift any food to the rear or second grate section 33, and, using a pair of tongs, hot pad, etc., pivot the front grate section 32 upwardly to enable access to the charcoal grate and the charcoal coals therebelow without requiring removal of the cooking grate such as to add, spread or otherwise adjust the coals.

FIG. 3A shows the cooking grate 27 in a cooking position, mounted above the charcoal grate, while FIG. 3C shows the cooking grate mounted above the charcoal grate, with the front grate section 32 being pivoted upwardly to allow access to the charcoal grate. In the embodiment shown, the front grate section 32 generally is shown as being approximately half the size of the cooking grate. However, although not shown, the hinges of the cooking grate can be moved further from the center portion thereof to provide a larger or smaller access opening 37 therein. Still further, although not shown, the cooking grate also can include more than one hinged section to provide for expansion of the access opening as needed or desired.

As illustrated in FIGS. 1 and 2, the bottom portion 12 of the body 11 of the grill 10 generally will be supported on a series of legs 41, here shown as including four legs 41A-41D. The legs 41 typically can be formed from a lightweight, high-strength material such as aluminum tube, although other types of materials can be used as well, and generally will be received within mounting cuffs 42 formed or attached to the lower end 43 of the grill bottom 12. The legs 41 generally will extend downwardly and outwardly from the lower end of the bottom portion of the grill body so as to provide a stable base or support. Wheels or rollers 46 generally will be mounted to at least two of the legs, with the wheels generally being connected together by an axle 47, although it is possible that the wheels can further be attached by other means so as to be independently rotatable as needed. The other two legs can include wheels or rollers, or alternatively, as indicated in FIGS. 1 and 2, can include feet 48 generally formed from a non-skid material such as plastic, rubber, etc. A storage shelf 49 also can be mounted along the legs, typically adjacent the lower portion thereof, and can provide further stability and support for the legs at their lower ends, while also providing a storage area for tools, bags of charcoal briquettes or other articles.

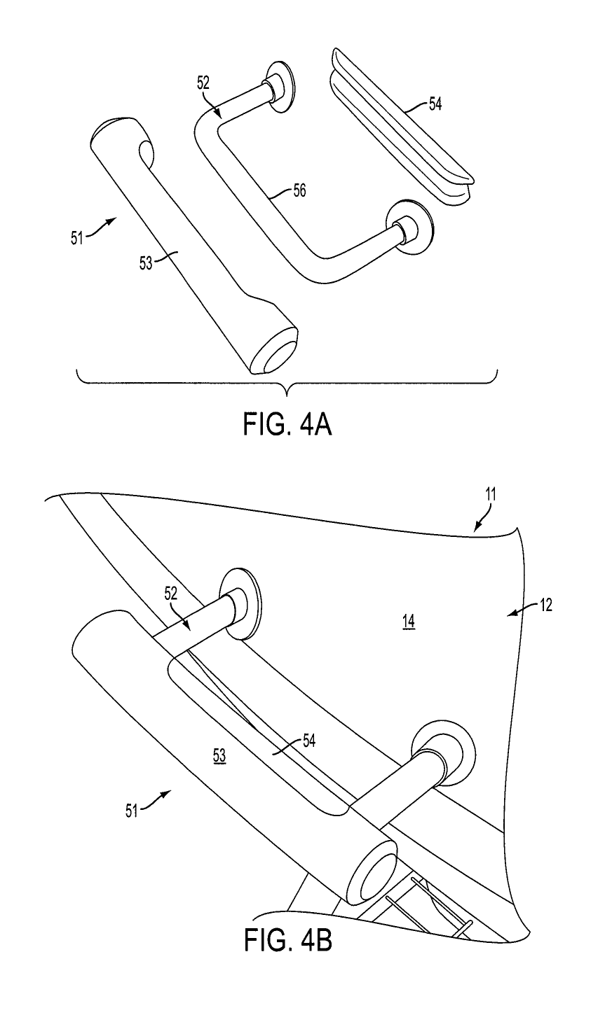

As further indicated in FIGS. 1 and 4A-4B, a handle 51 can be mounted to the bottom portion 12 of the body 11 of the grill 10 (FIG. 1) to assist in moving the grill to a desired location. The handle 51 generally includes a substantially U-shaped base 52 (FIG. 4A) that can be spot welded or otherwise affixed to the body of the grill, including by threaded fasteners, clips, etc., with the base and welded areas thereafter being powder coated with the rest of the grill body. A snap-together handle assembly including an elongated grip portion 53 and a rear or snap-fit type attachment portion 54 are received on opposite sides of the central portion 56 of the base 52 to complete the handle assembly. It will be understood that other types of handle assemblies and other configurations of the handle grip and snap portions also can be used to enable quick and easy change-out or replacement of the handle assembly as needed or desired.

The lid or top 13 of the grill body 11 is shown in further detail in FIGS. 1, 2 and 5. In the illustrated embodiment, the lid 13 generally is formed with a substantially concave structure, and is of a material and configuration matching the configuration of the bottom portion 12 of the grill body. In the embodiment illustrated, the lid or top includes a domed upper portion 61, and downwardly extending side walls 62 which define an upper heating chamber 63 and include a lower peripheral edge 64 that is adapted to seat upon and mate with the upper edge 16 of the side walls 14 of the bottom portion 12 of the grill body 11 in a substantially sealed arrangement. Thus, when the grill lid is in its closed position, heat from the burning coals will be contained within the upper chamber and cooking area of the grill for cooking food therein.

As additionally indicated in FIG. 1, a face plate 66 and a thermostat 67 can be mounted on one of the side walls 62 (typically a front-facing side wall of the grill lid) to provide a visual indication of the temperature within the grill during cooking. The nameplate can include various manufacturers' names, lighting or cooking instructions or other information. Additionally, although not shown, the analog thermostat 67 illustrated also can be replaced with a digital display.

Still further, a handle 69 generally is mounted below the thermostat along the peripheral edge 64 of the front side wall 62 of the lid to provide a means for gripping and lifting or closing the lid. The handle 69 generally will have a construction similar to that of handle 51, and can be formed from plastic or any other desired material. As also noted above, the handle further can be secured by methods other than spot welding such as by a threaded attachment, etc., and can be coated by other methods such as immersion or painting, for example.

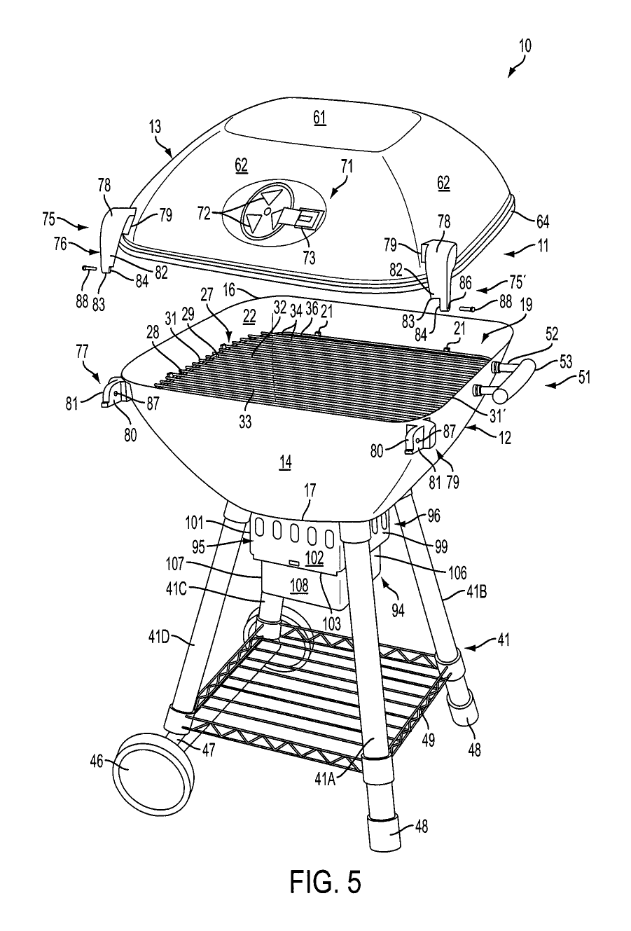

Additionally, as indicated in FIGS. 2 and 5, a vent 71 generally will be provided in a rear or side wall of the lid 13. The vent generally can include a conventional charcoal grill vent, including a series of openings 72 and a shutter 73 rotatably mounted over the vent openings and which can be rotated to open or close the vent openings to a desired amount for release of smoke and/or heat from the cooking chamber or area of the grill.

FIGS. 2 and 5 illustrate hinge assemblies 75 for attachment of the lid or top 13 to the bottom portion 12 of the body 11 of the grill 10. In general, each of the hinges 75 will include an upper or top portion 76 and a lower or bottom section 77. Each top portion 76 typically will be formed from a metal or similar high-strength material, and further can be cast or otherwise formed with the lid itself. In one embodiment, each top section can include a body 78 that can be attached to the lid or top of the grill such as by being cast, being welded or by fasteners inserted therethrough. For mounting of the top sections via fasteners, a mounting surface or face 79 generally will be formed at the upper end of the body 78 of each top section, with the mounting faces typically having a configuration or orientation adapted to mate with and sealingly engage against the outer surface of the side wall of the lid to which it is attached. Each bottom section 77 likewise will include a body 80 that can be cast with, or can be otherwise attached to the bottom portion of the grill body in similar fashion as with the top sections 76, by engagement of a mating face 81 of the body 80 against a side wall of the bottom portion and insertion of fasteners.

The lower end 82 of the body 78 of each top section further typically includes a cutout portion 83 defining a tongue 84 adapted to engage and mate with a mating or engagement face 85 or portion of the bottom section 77 of each hinge. A recessed opening or hole 86 generally is formed at the lower end 82 of each top section, with a corresponding hole or opening 87 being formed through the bottom section of each hinge for receipt of a hinge pin 88 therethrough. Each hinge pin further generally is secured in place with a cotter pin 89 or similar locking mechanism. As a result, the top and bottom sections 76 and 77 of each of the hinges 75 are secured together for attaching the top and bottom portions of the grill body in a pivoting arrangement, while still enabling the quick and easy release and removal of the hinge pin for complete removal of the lid or top of the grill as needed or desired.

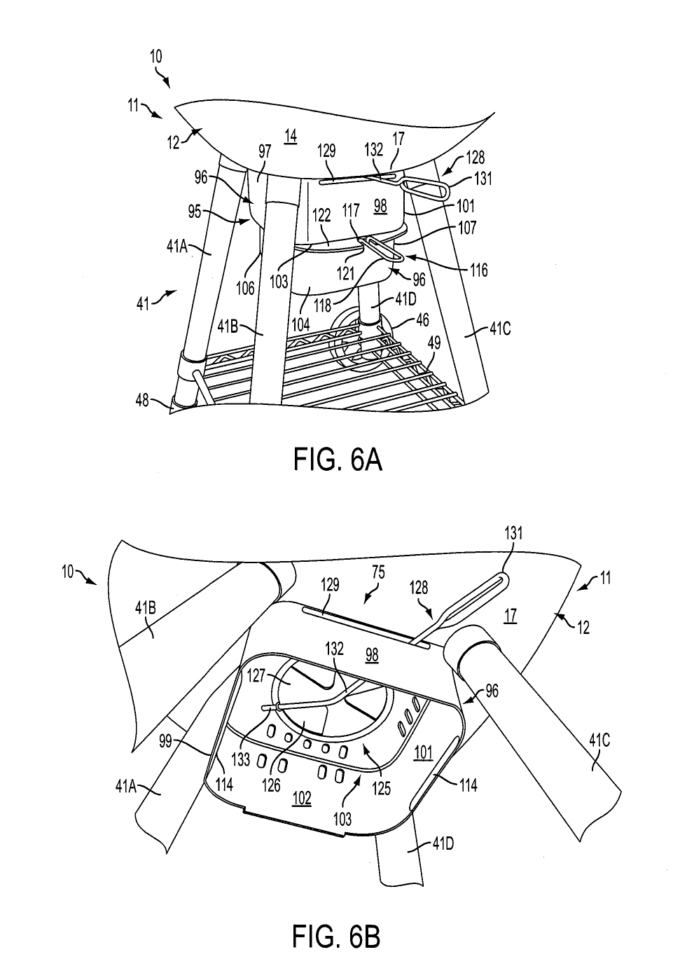

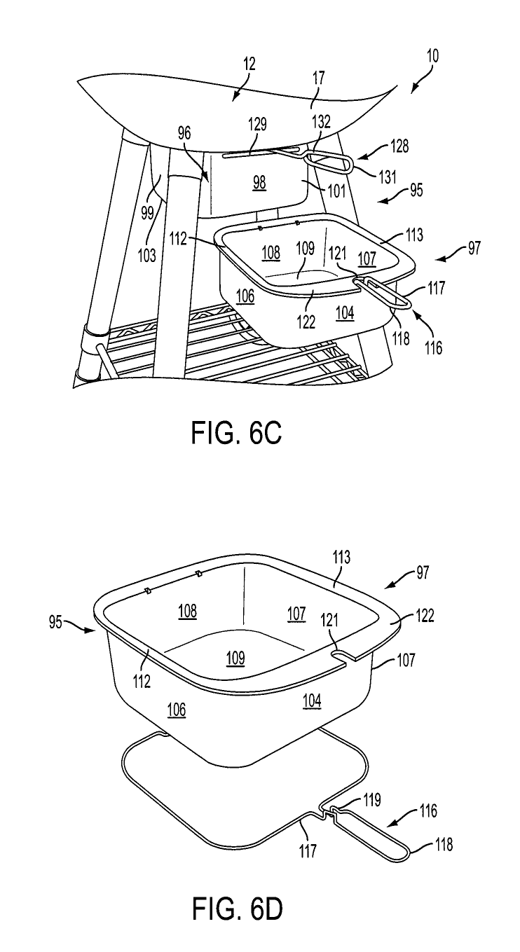

FIGS. 6A-6D illustrate the ash collection system 95 according to one embodiment of the present invention. As shown in FIGS. 6A-6C, the ash collection system 95 generally includes an upper ash collector 96 and an ash collection or catch pan 97. The upper ash collector generally can be formed with or can be attached to the lower end 17 of the bottom section 12 of the body 11 of the grill 10, such as by welding, by the insertion of fasteners such as rivets, bolts, etc. or can be releasably attached to enable breakdown of the grill for ease of transport. The upper ash collector 96 further generally will include a series of downwardly extending walls 98, 99, 101 and 102 that define a chamber or chute 103 for the discharge of ash from the grill.

The ash catch pan 97 generally will be formed from a metal material such as aluminum, steel or other heat-resistant material so as to be able to withstand the heat from hot ash being dropped therein, and typically will include a series of side walls 104, 106, 107 and 108, and a bottom 109 or base, with an ash receiving chamber 111 defined therein. As indicated in FIGS. 6C and 6D, the upper edges 112 and 113 of side walls 106 and 107 are formed with a substantially flat, outwardly flaring construction and are adapted to be slidably received and rest upon corresponding flanges or slides 114 (FIG. 6B) formed along the lower ends of side walls 99 and 101 of the upper ash collector. As a result, the ash catch pan 97 can be slidably received along the lower end of the upper ash collector 96, as indicated in FIG. 6C, for collection of ash discharged from the grill, and thereafter easily removed for discarding the ash.

In addition, as indicated in FIGS. 6C and 6D, a handle 116 can be removably mounted to the ash catch pan 97. The handle 116 generally is formed from a wire frame, as indicated at 117, and includes a grip portion 118 connected to the wire frame 117 by a snap connector 119. The snap connector fits within and engages the corresponding locking or snapping recess 121 formed in the upper edge 122 of the front or forward facing wall 104 of the ash catch pan. Thus, if needed, the handle can be removed to avoid inadvertent or unintentional removal of the ash catch pan from the upper ash collector.

As additionally indicated in FIG. 6B, a discharge vent 125 generally is provided in the lower end 17 of the bottom portion 12 of the grill body 11. The discharge vent generally will include a series of vent openings 126 and a shutter 127 rotatably attached to the bottom portion so as to be pivotable between open and closed positions for opening and closing the discharge openings 126 as needed or desired. Additionally, a handle 128 can be received through a slotted opening 129 formed in the upper portion of the front wall 98 of the upper ash collector 96. The handle 128 generally will include a grip portion 131 connected to a body portion 132 that extends through the slotted opening 129 and engages the shutter 127 at an opposite end 133 thereof. As the handle is moved laterally across the slotted opening, as indicated in FIGS. 6A and 6B, the shutter will progressively open and close the vent openings for controlling discharge of the ash from the grill and into/through the ash collection system. Once a desired amount of ash has been collected, the ash catch pan can be removed and the collected ash discarded, after which the ash catch pan will then be reinserted into engagement with the upper ash collector.

The foregoing description of the present invention illustrates and describes various embodiments thereof. As various changes could be made in the above-described construction without departing from the scope of the invention, it is intended that all matter contained in the above description or shown in the accompanying drawings shall be interpreted as illustrative and not in a limiting sense. Furthermore, the scope of the present invention covers various modifications, combinations, alterations, etc., of the above-described embodiments that are within the scope of the claims.

Additionally, while the disclosure shows and describes only selected embodiments of the invention, it will be understood that the invention is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the invention.

What is claimed is:

1. A grill, comprising:
a body having a bottom portion defining a cooking area, and a top portion pivotally attached to the bottom portion;
a charcoal grate received and mounted within the bottom portion at a first elevation;
a cooking grate received and mounted within the bottom portion in a position spaced above the charcoal grate;
a series of legs mounted to the bottom portion for supporting the grill; and
an ash collection system mounted to a lower end of the bottom portion, the ash collection system including an upper ash collector defining a discharge chute, an ash catch pan removably received within the upper ash collector for collecting discharged ash, and an adjustable vent mounted in the lower end of the bottom portion of the body for controlling discharge of ashes through the ash collection system.

2. The grill of claim 1 and wherein the cooking grate comprises a frame, a first section hingedly attached to the frame, and a second section fixedly mounted to the frame, wherein the first section is pivotable upwardly and away from the charcoal grate so as to define an access opening in the cooking grate to enable access to the charcoal grate therebelow.

3. The grill of claim 2 and wherein the cooking grate includes additional hinged sections to enable variation in size of the access opening.

4. The grill of claim 1 and wherein the top and bottom portions are attached by a pair of hinges along peripheral side walls thereof.

5. The grill of claim 4 and wherein the hinges are cast with the top and bottom portions of the body.

6. The grill of claim 4 and wherein each hinge comprises a top section having a mounting face adapted to matingly engage with a side wall of the top portion of the body, a bottom section that matingly engages the bottom portion of the body and which includes an engagement face that mates with a tongue portion of the top section, and a hinge pin extended through the mating engagement face and tongue portions of the bottom and top sections.
